(19) United States
(12) Patent Application Publication
(10) Pub. No.: US 2015/0075496 A1
(43) Pub. Date: Mar. 19, 2015

(54) Fastening Assembly For A Fuel Rail Of A Combustion Engine

(71) Applicant: Continental Automotive GmbH, Hannover (DE)

(72) Inventors: Marco Pasquali, Livorno (IT); Giandomenico Serra, Loc. Ghezzano - S. Giuliano Terme (IT)

(21) Appl. No.: 14/489,762

(22) Filed: Sep. 18, 2014

(30) Foreign Application Priority Data
Sep. 18, 2013 (EP) 13185035

(51) Int. Cl. F02M 63/02; F02M 55/02

(52) U.S. Cl. CPC F02M 63/0275; F02M 55/025
USPC 123/469; 248/65

(57) ABSTRACT

A fastening assembly for mounting a fuel rail in an engine includes a bracket which includes a longitudinal axis and is coupled to the fuel rail, a retainer which includes a first through opening for receiving a bolt, and a bolt which is inserted through the first through opening. The bracket includes a second through opening for receiving the retainer and the bolt. The retainer is arranged in the second through opening such that it can rotate relative to the bracket. The cross-section of the first through opening perpendicular to the longitudinal axis has an elongated shape.

### CROSS-REFERENCE TO RELATED APPLICATIONS

This application claims priority to EP Patent Application No. 13185035 filed Sep. 18, 2013. The contents of which are incorporated herein by reference in their entirety.

### TECHNICAL FIELD

The invention relates to a fastening assembly for a fuel rail in an engine comprising a bracket and a bolt wherein the bracket is coupled to the fuel rail.

### BACKGROUND

The delivery and assembly of a fuel rail in an engine environment is often associated with particular customer requirements regarding the position of the bolts used to affix the fuel rail to the cylinder head. In order to avoid any possible collisions and subsequent damage during the insertion of the fuel rail into its assembly position, it is often required by the customer that the bolts be in an upper position where only the bolt dog end (i.e. the tapered end portion of the bolt opposite to the bolt head where no threading is present) protrudes from the bottom surface of the bracket. This request is often presented together with the request to include a capture function in the fuel rail clamping bolt (i.e. a function to ensure that the bolt does not become detached during transportation or assembly).

These special customer requirements must be combined with the general requirement to enable sufficient radial and lateral tolerance during assembly. This is very important to avoid forcing and deforming of components which creates mounting stress and reduces the lifetime of the system.

### SUMMARY

One embodiment provides a fastening assembly for mounting a fuel rail in an engine comprising a bracket which includes a longitudinal axis and is coupled to the fuel rail, a retainer which comprises a first through opening for receiving a bolt, and a bolt which is inserted through the first through opening, wherein the bracket comprises a second through opening for receiving the retainer and the bolt, wherein the retainer is arranged in the second through opening such that it can rotate relative to the bracket and wherein the cross-section of the first through opening perpendicular to the longitudinal axis has an elongated shape.

In a further embodiment, the bolt comprises a bolt dog end which is opposite to the head of the bolt and where no threading is present, whereby the bolt is inserted through the first through opening such that the bolt dog end protrudes beyond the bracket.

In a further embodiment, the bracket is coupled to the fuel rail via an injector cup.

In a further embodiment, the bracket and injector cup are formed as one piece.

In a further embodiment, the second through opening has a circular cross-section perpendicular to the longitudinal axis and the exterior shape of the retainer is cylindrical.

In a further embodiment, the negative shape of the second through opening corresponds approximately to the positive shape of the exterior of the retainer.

In a further embodiment, the cross-section of the first through opening perpendicular to the longitudinal axis has an elongated circular or an oval shape.

In a further embodiment, the surface of the retainer facing the bracket has a circumferential tongue.

In a further embodiment, the tongue can engage with a corresponding circumferential groove on the surface of the bracket facing the retainer.

In a further embodiment, the surface of the retainer facing the bracket has a circumferential groove which can engage with a corresponding circumferential tongue on the surface of the bracket facing the retainer.

### BRIEF DESCRIPTION OF THE DRAWINGS

Example embodiments of the invention are explained below with reference to the drawings, in which:

FIG. 1 shows a perspective view of a first embodiment,

FIG. 2 shows a perspective view of a retainer according to the first embodiment,

FIG. 3 shows a cross-sectional view of the first embodiment in the plane A-A,

FIG. 4 shows a cross-sectional view of the first embodiment in the plane B-B,

FIG. 5 shows a cross-sectional view of a section of a second embodiment, and

FIG. 6 shows a cross-sectional view of a section of a third embodiment.

### DETAILED DESCRIPTION

Embodiments of the invention provide a fastening assembly for a fuel rail in a combustion engine which can facilitate reliable delivery and assembly of a fuel rail.

A fastening assembly for mounting a fuel rail in an engine is disclosed. The fastening element may, for example, be configured for fastening the fuel rail to a cylinder head of the engine, the engine being in particular an internal combustion engine. The fastening assembly comprises a bracket which includes a longitudinal axis. The fastening assembly further comprises a retainer and a bolt. The retainer comprises a first through opening for receiving the bolt. The first through opening in particular extends through the retainer in longitudinal direction. The bolt is inserted through the first through opening. The main extension direction of the bolt is preferably parallel or coaxial to the longitudinal axis.

The retainer is operable to hold the bolt in a given longitudinal position through friction between the bolt and the retainer. The retainer is preferably made from an elastic material or elastic materials which are able to grip the bolt. In this way, the bolt is securely held in position during delivery and assembly of the fuel rail in the engine.

The bracket is coupled to the fuel rail. In a preferred embodiment, the bracket is coupled to the fuel rail via an injector cup. The injector cup and bracket are preferably formed as one piece.

The bracket comprises a second through opening for receiving the retainer and the bolt. The second through opening extends in particular through the bracket in longitudinal direction. For example, the longitudinal axis is defined by a central axis through the second through opening.

The retainer is arranged in the second through opening such that it can rotate relative to the bracket. The retainer and the bracket preferably share the longitudinal axis as central axes of the first and second through holes, respectively. The second through opening preferably exhibits a circular cross-section perpendicular to the longitudinal axis and the exterior shape of the retainer is preferably cylindrical. In this way, rotation of the retainer about its own central axis is facilitated.

The cross-section of the first through opening perpendicular to the longitudinal axis has an elongated shape. An elongated shape includes a long hole, a long slot and an oval hole. The elongated shape allows the inserted bolt to move in both directions of the elongation. This means that the bolt can be moved into an excentric position—i.e. a position spaced from the longitudinal axis—relative to the retainer and bracket. This in combination with the feature that the retainer can rotate relative to the bracket, allows the bolt (when in a excentric position) to be moved along the circumference of a imaginary circle centered around the longitudinal axis. The radius of the imaginary circle is dependent on the lateral deviation of the bolt along the elongated first through opening from the longitudinal axis. In this way, the fastening assembly offers lateral and radial tolerance for positioning the fuel rail (and injectors) into the dedicated position in the engine.

In one embodiment, the cross-section of the first through opening perpendicular to the longitudinal axis has an elongated circular or an oval shape. An elongated circular shape is in particular a contour which has circle sections at opposing ends, the circle sections being connected to one another by intermediate sections which are straight or which are bent more weakly than the circle sections. The circle sections are preferably half circles. The elongated circular shape may be an ellipse in one development. If the cross-section of the first through opening were not elongated, but for instance circular, the retainer would be able to secure the vertical position of the bolt, but would not be able to offer lateral or radial tolerance during assembly.

In one embodiment, the bolt comprises a bolt dog end which is opposite to the head of the bolt and where no threading is present, whereby the bolt is inserted through the first through opening such that the bolt dog end protrudes beyond the bracket. In one development, only the bold dog end protrudes beyond the bracket on aside of the bracket opposite the bolt head.

Having only the bolt dog end protruding beyond the second through opening of the bracket is advantageous, because this corresponds to the ideal starting position of the bolt for assembly. In this way, the engine is also protected from the sharp threading of the bolt. Otherwise, it can be foreseen that in practice a part of the threading of the bolt may protrude beyond the bracket.

In a further embodiment, the negative shape of the second through opening corresponds approximately to the positive shape of the exterior of the retainer. This mating form ensures that the retainer does not slip out of the second through opening of the bracket and prevents loss of the bolt and retainer.

In a further embodiment, the surface of the retainer facing the bracket has a circumferential tongue. The surface facing the bracket is in particular an outer circumferential surface of the retainer and may expediently face away from the longitudinal axis. The tongue includes a rib or ridge on the surface of the retainer facing the bracket. The circumferential tongue can be continuous or discontinuous (e.g. segmented). In the continuous form, the circumferential tongue resembles a ring around the retainer. The circumferential tongue of the retainer creates additional friction to maintain the position of the bolt and retainer relative to the bracket.

In a further embodiment, the circumferential tongue of the retainer can engage with a corresponding circumferential groove on the surface of the bracket facing the retainer. The surface of the bracket facing the retainer is in particular a circumferential surface of the second through hole.

In one embodiment, the surface of the retainer facing the bracket has a circumferential groove which can engage with a corresponding circumferential tongue on the surface of the bracket facing the retainer. A circumferential groove in the retainer or bracket can be continuous or discontinuous (e.g. segmented) as can a circumferential tongue in the retainer or bracket.

The injector can be mounted either by the suspended or clamped method.

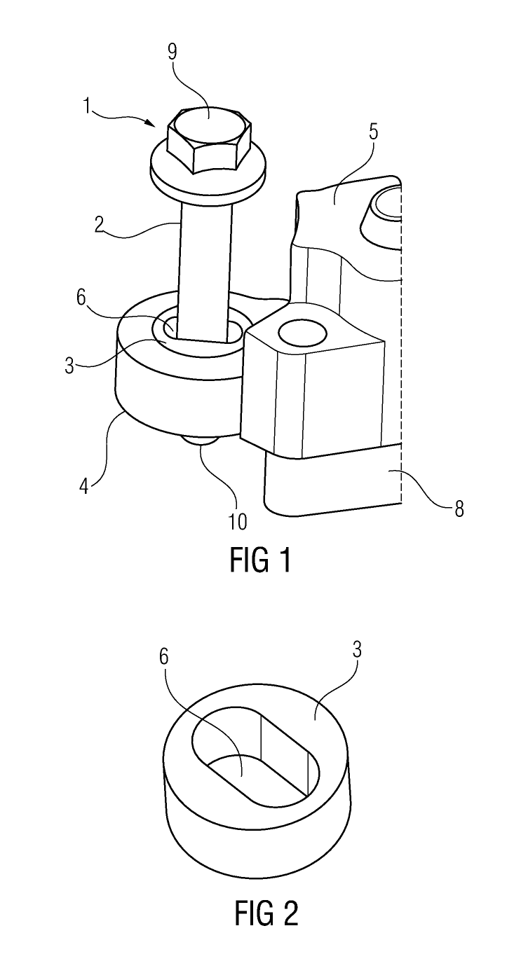

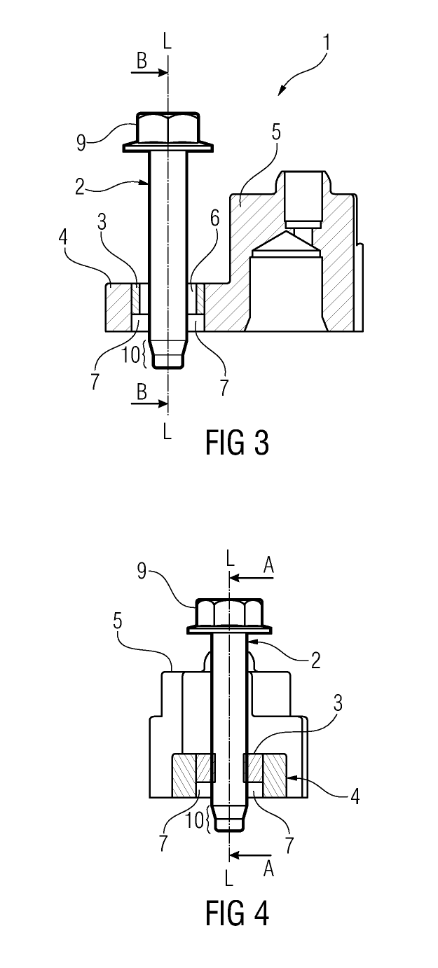

FIG. 1 shows a section of a fastening assembly 1 including a bolt 2, a retainer 3 and a bracket 4 which is coupled to an injector cup (partially shown in FIG. 1). The retainer 3 includes a first through opening 6 through which the bolt 2 is inserted. The bracket 4 comprises a second through opening 7 in which the retainer 3 is movably arranged. The second through opening 7 is circular in cross-section perpendicular to a central longitudinal axis L (see FIGS. 3 and 4). A connection plate 8 for the mounting of an injector is shown in FIG. 1.

A perspective view of the retainer 3 is shown alone in FIG. 2. The first through opening 6 has a elongated circular cross-section (i.e. an elongated hole). The through opening 6 extends completely through the retainer 3 in longitudinal direction L. The exterior form of the retainer 3 is cylindrical with the cylinder axis in particular coinciding with the longitudinal axis L.

FIGS. 3 and 4 show two different cross-sections of the fastening assembly 1 pictured in FIG. 1. An injector is not featured in these diagrams. The bolt 2 is pictured in a central position within the first through opening 6. The end of the bolt 2 opposite to the bolt head 9 is tapered and does not include any threading. This end is the bolt dog end 10.

The lateral tolerance available during assembly is visible in FIG. 3, i.e. the clearance between the retainer 3 and the bolt 2 (the first through opening 6). It can been seen from the cross-section in FIG. 4 that in this plane the bolt 2 is tightly held by the retainer 3. In other words, the bolt 2 is spaced apart from the retainer 3 within the first through opening 6 in a first lateral direction and contacts the retainer 3 within the first through opening 6 in a second lateral direction, different from the first lateral direction. The retainer 3 is made from an elastic material which partially grips around the bolt 2. In FIG. 4 the retainer 3 extends partially into the bolt 2 due to its elasticity.

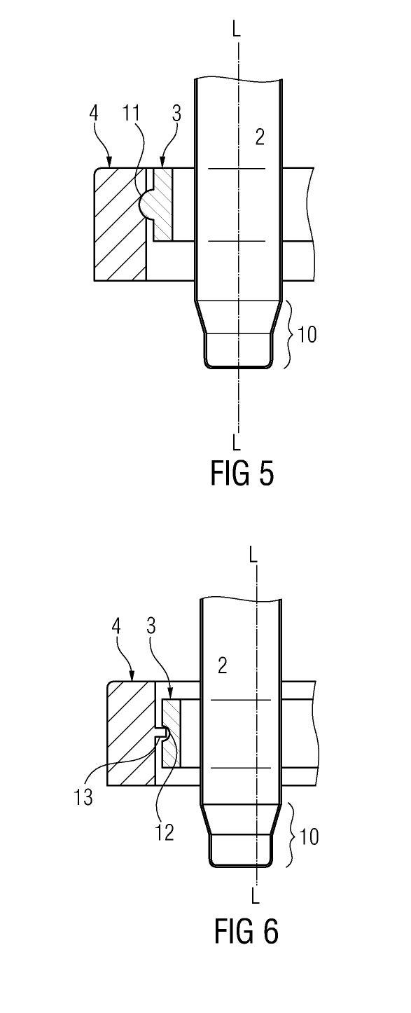

FIG. 5 shows a second exemplary embodiment of the invention which in general corresponds to the first embodiment described above. However, in the present embodiment, the retainer 3 of the present embodiment includes a circumferential tongue (or ridge) 11 on the surface facing the bracket 4. This tongue 11 is continuous and integrated in the retainer 3 and is therefore also made of elastic material. The tongue 11 can therefore be elastically deformed to prevent the retainer 3 from slipping out of the second through opening 7 in the vertical direction. The retainer 3 is still able to rotate relative to the bracket 4 around the central longitudinal axis L. In one development, the bracket 4 may comprise a circumferential groove (not shown in the figures) in the surface of the second through opening 7 corresponding to the tongue 11.

FIG. 6 shows an alternative to the example in FIG. 5 as the third exemplary embodiment of the invention. The retainer 3 includes a circumferential groove 12 and the bracket 4 includes a circumferential tongue 13. The groove 12 and tongue 13 interact to secure the vertical position of the retainer 3 in the second through opening 7 of the bracket 4. The retainer 3 is still able to rotate relative to the bracket 4 around the central longitudinal axis L. The bolt 2 in this example is located off-center to the central longitudinal axis L. The bolt 2 is therefore able to be adjusted radially, i.e. moved long the circumference of an imaginary circle.

What is claimed is:

1. A fastening assembly for mounting a fuel rail in an engine, comprising:
a bracket coupled to the fuel rail and having a longitudinal axis,
a retainer comprising a first through opening for receiving a bolt, and
a bolt inserted through the first through opening,
wherein the bracket comprises a second through opening configured to receive the retainer and the bolt,
wherein the retainer is arranged in the second through opening such that the retainer is rotatable relative to the bracket, and
wherein a cross-section of the first through opening perpendicular to the longitudinal axis of the bracket has an elongated shape.

2. The fastening assembly of claim 1, wherein the bolt comprises a bolt dog end located opposite the head of the bolt and being free of threading, wherein the bolt is inserted through the first through opening such that the bolt dog end protrudes beyond the bracket.

3. The fastening assembly of claim 1, wherein the bracket is coupled to the fuel rail via an injector cup.

4. The fastening assembly of claim 3, wherein the bracket and injector cup are formed as one piece.

5. The fastening assembly of claim 1, wherein the second through opening has a circular cross-section perpendicular to the longitudinal axis of the bracket, and wherein an exterior shape of the retainer is cylindrical.

6. The fastening assembly of claim 1, wherein a negative shape of the second through opening corresponds approximately to a positive shape of the exterior of the retainer.

7. The fastening assembly of claim 1, wherein the cross-section of the first through opening of the retainer perpendicular to the longitudinal axis of the bracket has an elongated circular shape or an oval shape.

8. The fastening assembly of claim 1, wherein the surface of the retainer facing the bracket has a circumferential tongue.

9. The fastening assembly of claim 8, wherein the tongue is configured to engage with a corresponding circumferential groove on the surface of the bracket facing the retainer.

10. The fastening assembly of claim 1, wherein the surface of the retainer facing the bracket has a circumferential groove configured to engage with a corresponding circumferential tongue on the surface of the bracket facing the retainer.

11. An engine, comprising:
a fuel rail,
a fastening assembly for mounting the fuel rail in the engine, the fastening assembly comprising:
fastening assembly for mounting a fuel rail
a bracket coupled to the fuel rail and having a longitudinal axis,
a retainer comprising a first through opening for receiving a bolt, and
a bolt inserted through the first through opening,
wherein the bracket comprises a second through opening configured to receive the retainer and the bolt,
wherein the retainer is arranged in the second through opening such that the retainer is rotatable relative to the bracket, and
wherein a cross-section of the first through opening perpendicular to the longitudinal axis of the bracket has an elongated shape.

12. The engine of claim 11, wherein the bolt of the fastening assembly comprises a bolt dog end located opposite the head of the bolt and being free of threading, wherein the bolt is inserted through the first through opening such that the bolt dog end protrudes beyond the bracket.

13. The engine of claim 11, wherein the bracket of the fastening assembly is coupled to the fuel rail via an injector cup.

14. The engine of claim 13, wherein the bracket and injector cup are formed as one piece.

15. The engine of claim 11, wherein the second through opening of the bracket has a circular cross-section perpendicular to the longitudinal axis of the bracket, and wherein an exterior shape of the retainer is cylindrical.

16. The engine of claim 11, wherein a negative shape of the second through opening of the bracket corresponds approximately to a positive shape of the exterior of the retainer.

17. The engine of claim 11, wherein the cross-section of the first through opening of the retainer perpendicular to the longitudinal axis of the bracket has an elongated circular shape or an oval shape.

18. The engine of claim 11, wherein the surface of the retainer facing the bracket has a circumferential tongue.

19. The engine of claim 18, wherein the tongue is configured to engage with a corresponding circumferential groove on the surface of the bracket facing the retainer.

20. The engine of claim 11, wherein the surface of the retainer facing the bracket has a circumferential groove configured to engage with a corresponding circumferential tongue on the surface of the bracket facing the retainer.
